(19) United States
(12) Patent Application Publication
(10) Pub. No.: US 2014/0019856 A1
(43) Pub. Date: Jan. 16, 2014

(54) Serving Font Glyphs

(71) Applicant: GOOGLE INC., Mountain View, CA (US)

(72) Inventors: Nestor Hernandez, San Francisco, CA (US); Douglas R. Bengtson, Redwood City, CA (US); Dmitriy Portnov, San Jose, CA (US); Manish Gupta, Santa Clara, CA (US); Alexei Y. Barski, Mountain View, CA (US)

(73) Assignee: GOOGLE INC., Mountain View, CA (US)

(21) Appl. No.: 14/034,030

(22) Filed: Sep. 23, 2013

Related U.S. Application Data
(63) Continuation of application No. 12/401,217, filed on Mar. 10, 2009.

(51) Int. Cl. G06F 17/21

(52) U.S. Cl. CPC G06F 17/214
USPC 715/269

(57) ABSTRACT

A computer-implemented method for obtaining a font for a document includes determining each glyph of a font that is specified in contents of an electronic document, the determination identifying a subset of multiple glyphs included in the font, the subset determined on a first device that does not have the font stored thereon. The method includes generating on the first device a request to a second device based on the determination, the request identifying the subset to the second device. The method includes receiving, at the first device, information sent from the second device in response to the request and defining the subset of the multiple glyphs, the information not defining a remainder of the multiple glyphs other than the subset. The method includes generating on the first device a presentation of the electronic document using the received information, the presentation including the subset of the multiple glyphs.

### TECHNICAL FIELD

This document relates to information processing.

### BACKGROUND

Computer systems are used to distribute various kinds of content. One example of content is advertising, where advertisements can be presented on a computer screen, on a television screen or on a billboard, to name just a few examples. Content such as an advertisement can be created for display to all members of a general intended audience, or the content presentation can be determined on a user-by-user basis, for example.

Text included in content can be generated using one or more fonts. A font can include characters that make up a complete typeface, of which common examples are Times, Courier and Helvetica. Content in languages other than English can use no-Latin scripts for rendering a message. Fonts are sometimes packaged together with a particular electronic document, such as an advertisement. When collected in a file, some non-Latin scripts can occupy a significant amount of storage space, such as on the order of 20 MB.

### SUMMARY

In a first aspect, a computer-implemented method for obtaining a font for a document includes determining each glyph of a font that is specified in contents of an electronic document, the determination identifying a subset of multiple glyphs included in the font, the subset determined on a first device that does not have the font stored thereon. The method includes generating on the first device a request to a second device based on the determination, the request identifying the subset to the second device. The method includes receiving, at the first device, information sent from the second device in response to the request and defining the subset of the multiple glyphs, the information not defining a remainder of the multiple glyphs other than the subset. The method includes generating on the first device a presentation of the electronic document using the received information, the presentation including the subset of the multiple glyphs.

Implementations can include any or all of the following features. A user can make a revision in the electronic document during the presentation, and the method can further include determining that the revision includes at least another glyph of the font not specified by the information; generating a new request to the second device regarding the other glyph; receiving additional information from the second device defining the other glyph; and updating the presentation to display also the other glyph in the electronic document. The determination that the revision includes at least the other glyph can be performed in response to detecting that a predetermined time passes after the user makes the revision. A first user can create the electronic document on a third device and a second user can modify the electronic document on the first device. An application program can be executed on the first and third devices and used in creating and modifying the electronic document. The application program can have stored therein an address of the second device for requesting the information, and the request can be generated using the address. The electronic document can have stored therein an address of the second device for requesting the information, and the request can be generated using the address. The electronic document can include an advertisement directed to a user operating the first device, and the presentation can include displaying the advertisement to the user. The font can be identified by a font identifier in the electronic document and each of the subset of the multiple glyphs can be specified using a codepoint in the electronic document.

In a second aspect, a computer-implemented method for providing a custom font for a document includes receiving a first input in a first device, the first input specifying a subset of multiple glyphs of a custom font to form contents of an electronic document. The method includes receiving a second input in the first device, the second input comprising information defining the multiple glyphs of the custom font. The method includes forwarding the information to a second device configured to provide the information upon request from a recipient of the electronic document. The method includes forwarding the electronic document to a third device that does not have the custom font stored thereon, wherein the third device requests the information from the second device.

Implementations can include any or all of the following features. The electronic document can include an advertisement directed to a user operating the third device, and the third device can display the advertisement to the user including the subset of the multiple glyphs. The font can be identified by a font identifier in the electronic documents and each of the subset of the multiple glyphs can be specified using a codepoint in the electronic document. The font can include a non-Latin script and each of the multiple glyphs can be a non-Latin glyph.

In a third aspect, a system includes a font database comprising information defining at least one font comprising multiple glyphs. The system includes a font packaging component configured to receive a request from a device and in response forward information obtained from the font database, the information defining a subset of the multiple glyphs identified in the request and not a remainder of the multiple glyphs other than the subset.

Implementations can include any or all of the following features. The system can further include an application program executed in the system and operated by a user to create the electronic document. The electronic document can have stored therein an address of the font database for requesting the information, and the device can generate the request using the address. The application program can also be executed on the device and have stored therein an address of the font database for requesting the information, and the device can generate the request using the address. The application program can provide for a user of the device to enter a revision of the electronic document, and the device can generate a new request to the font server upon determining that the revision includes at least another glyph of the font not specified by the information. The system can further include a font server that includes the font database and the font packaging component, the application program interacting with the font server in creating the electronic document. The font server can communicate a font availability to the application program.

Implementations can provide any or all of the following advantages. Presentation of an electronic document can be improved by dynamic serving of a font. A subset of glyphs of a font needed for an electronic document can be packaged and served to the device that is to display the document. A document creator can define a custom font for the document and upload the custom font to a server from which the system receiving the document will request the font for presentation.

The details of one or more implementations are set forth in the accompanying drawings and the description below. Other features and advantages will be apparent from the description and drawings, and from the claims.

### DESCRIPTION OF DRAWINGS

FIG. 1 shows an example graphical user interface that can be used for creating an electronic document.

FIG. 2 shows an example system that can serve part or all of a font.

FIG. 3 shows an example system that includes a font server.

FIG. 4 shows a table with example compile times and file sizes.

FIG. 5 shows a flowchart of an example method for obtaining a font for a document.

FIG. 6 shows a flowchart of an example method for providing a custom font for a document.

FIG. 7 is a block diagram of a computing system that can be used in connection with computer-implemented methods described in this document.

Like reference symbols in the various drawings indicate like elements.

### DETAILED DESCRIPTION

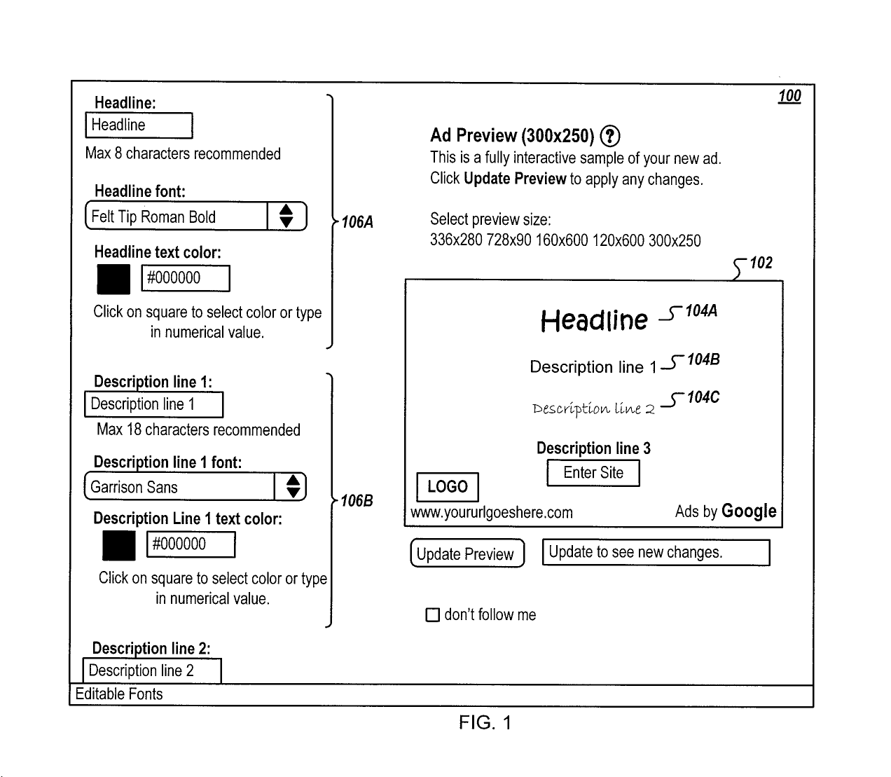

FIG. 1 shows an example graphical user interface 100 that can be used for creating an electronic document. In some implementations, a document creator such as an advertisement designer uses the interface 100 to create a document (e.g., an ad) for review by and/or display to one or more other people (e.g., an ad editor or an ad recipient). For example, the interface 100 can allow the creator to use one or more fonts (such as an existing font or a custom font defined by the creator) in the document; the system or application receiving the created document can retrieve, from a designated font server, as much of the font as necessary for displaying the document.

The interface 100 can include a preview area 102. The preview area 102 can include one or more content portions such as images, graphics, text, links or any other content that the creator chooses to include in the document. Here, the preview area 102 currently includes text portions 104A-C, among others. The interface 100 can include one or more areas 106 dedicated to formatting content for the document. In some implementations, formatting can be applied on a portion-by-portion basis for the included content. For example, the area 106A can be used to choose one or more formatting aspects for the portion 104A, and the area 106B similarly for the portion 104B, and so on. In some implementations, the creator can enter a text content of the portion, choose a font for the portion, and/or select a color for the portion using the area 106. For example, the text portion 104A here includes the content “Headline” written using the font Felt Tip Roman Bold in the color identified as “#000000”.

As such, the created document, such as an ad, will contain content portions that may require use of one or more fonts for display. That is, when the document is forwarded to another user, such as to an editor or final recipient, the receiving system will use part or all of the font(s). The required font can be embedded in the electronic document or otherwise stored in the receiving system. If so, the receiving system can retrieve the font from that location and display the document. As another example, the font may be available from a dynamic font server and the receiving system can request the font from the font server for use with the particular document. In some implementations, only as much of the font as is necessary for the display is requested and/or transferred. For example, if the receiving system only needs, say, about 10% of the glyphs of the font, the system can indicate this in the request and the font server can package and return that subset in response to the request.

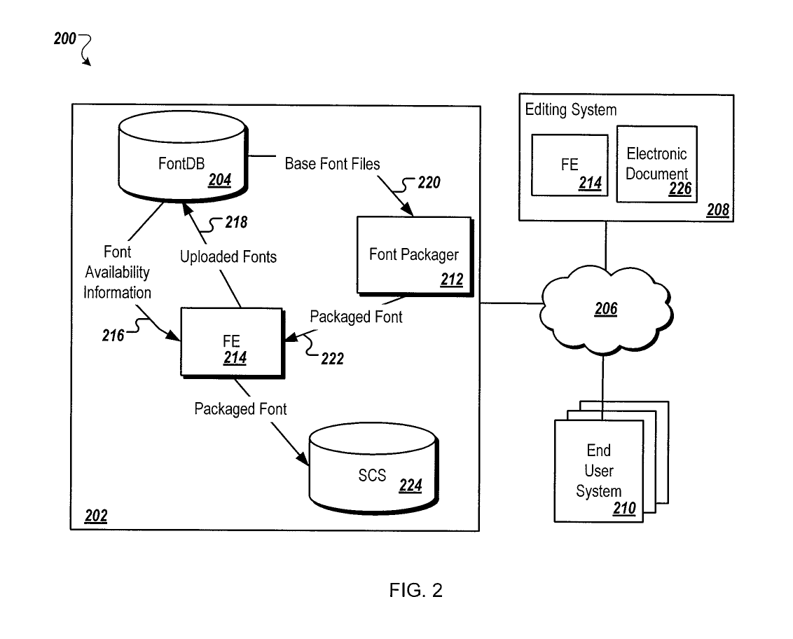

FIG. 2 shows an example system 200 that can serve part or all of a font. The system 200 can include a computer system 202 that can include predefined and/or custom fonts in a font database 204. The computer system 202 can include any kind of computer device including, but not limited to, a server device. The font database 204 includes information that defines at least one font comprising multiple glyphs, such as any or all glyphs of the font Felt Tip Roman Bold mentioned in the above example. The computer system 202 can be connected to any kind of network 206, such as to a local network and/or to the internet. Through the network 206, the computer system 202 can communicate with one or more other systems, such as with an editing system 208 and/or with an end user system 210. For example, the computer system 202 can serve one or more glyphs for use by the system 208 and/or 210 in presenting an electronic document such as an ad.

In some implementations, the font database 204 can contain any or all of the following font information items: a font identifier, a font name, a font language, a font script, font available Unicode characters, an image preview of the font, a user identifier (e.g., for a custom defined font), base font file bytes, and/or base font file hash. In some implementations, a font name can be localized, such as by having one font name for English, another font name for Chinese, and so on. A local font name can be used in presenting available fonts to users in different locales. Upon a font being uploaded to the font database 204 (such as a custom font), basic registration for the font can be performed (in some implementations including language and/or script determination). The font database 204 can interface with one or more components, for example to provide functionality for the following use cases. A document creator can be shown a list of relevant fonts while editing. For example, language information for each font can be used, such as to allow user selection. For example, information about available glyphs for each font can be used, such as for user feedback when a specified character cannot be rendered. For example, information about font ownership can be maintained, such as for showing a particular account's custom fonts. A custom font can be uploaded. For example, the owner of the custom font can be registered. For example, information about the font can be registered, such as available characters. For example, a unique font identifier can be generated. For example, a quota per account can be established and tracked. Access to original font file bytes can be granted, such as for copying to local file caches.

The computer system 202 can include a font packager 212. The font packager 212 can include the necessary infrastructure for dividing any font into a subset containing the glyph(s) needed for a particular document and compiling the glyph(s) into a file, such as a .swf file. In some implementations, the font packager 212 can receive a request from a device such as the system 208 and/or 210. The request can be generated because the system needs a certain font to display or otherwise present an electronic document. For example, the request can identify the glyph(s) of a particular font that the system 208 and/or 210 needs. In response to the request, the system 202 can forward information obtained from the font database 204. In some implementations, such information can define a subset of the multiple glyphs identified in the request and not a remainder of the multiple glyphs other than the subset. For example, the information in the response can include only the specified glyph(s) of a particular font. Fonts and/or glyphs can be defined using any suitable structure of information. For example, the font can identified by a font identifier in the electronic document and one or more glyphs can be specified using a codepoint in the electronic document.

In some implementations, the font packager 212 can create the requested package using a labeled font subset that includes a font identifier for the font in the font database 204 and an accompanying base file, a label including a font name by which the subset can be referred, and a set of codepoints (e.g., a Unicode set) to be packaged.

The document creator can use a frontend application 214 in one or more aspects of managing the electronic document. In some implementations, the frontend application 214 can generate the interface 100 (FIG. 1) and/or can be used for creating a document such as an ad. The font database 204 can provide font availability information 216 to the frontend application 216, for example such that one or more available fonts can be identified in the area(s) 106 (FIG. 1). The frontend application 214 can provide one or more uploaded fonts 218 to the font database 204, for example a custom font that the document creator provides to the database. A custom font can be defined in any suitable way, such as by creating definitions for vector graphics such that font glyphs can be generated in more than one font size and/or style (e.g., in boldface). For example, a font can be defined using any suitable font format, such as in form of a TrueType font, an OpenType font, or a Type 1 font, to name just a few examples.

The font database 204 can provide one or more base font files 220 to the font packager 212. For example, the font database 204 can provide the glyph(s) sought by another system such as the system 208 and/or 210. The font packager 212 can generate a packaged font 222 using the obtained fonts, for example in form of a .swf file or any other suitable format. In some implementations, the entire font is made available from the font database to the font packager, which selects the necessary glyphs and packages them. In some implementations, the font packager requires only the needed glyphs from the font database and packages them after receipt.

The frontend application 214 can take one or more actions with regard to the packaged font 222. For example, the frontend application can forward the packaged font 222 to the system 208 and/or 210 for use in displaying or otherwise presenting an electronic document. As another example, the frontend application can use the packaged font 222 in creating a version of the electronic document (e.g., by replacing codepoints and/or other glyph placeholders in the document with the actual glyph chosen by the creator). Such a created version of an electronic document can be stored in a static content server 224. In some implementations, image(s) of a created document can be stored in the server 224 and thereafter provided to one or more viewers. For example, a created advertisement using a particular font can be stored in the server 224 and be served to any or all of the end user systems 210 upon a predefined event, such as that the user enters a particular search query or visits a certain page or site.

It was mentioned above that the electronic document can be stored, such as in the server 224. As another example, the packaged font can be stored. In some implementations, this can allow multiple documents to refer to, and use, the packaged font. For example, an advertisement document can exist in different size variations that all include the same text, or some variations can use only a subset of the supported text of another variation. A stored font package, such as a font .swf file, can allow multiple variations to use a common file.

The editing system 208 can be used for editing an electronic document 226. For example, the document 226 may have been created on the system 202 by an ad creator using the frontend application 214. Then, an ad editor can make selected changes in the document 226 using the same application 214 or another application. Accordingly, one user can create the electronic document 226 on one device and another user can modify the electronic document 226 on another device. The other device (e.g., the system 208 and/or 210) can determine what glyph(s) the electronic document 226 requires, for example by reading each codepoint defined in the document. The other device can then generate a request to the system 202 based on such a determination. For example, the request can identify the subset of glyphs that is needed. In some implementations, the font includes a non-Latin script (such as, but not limited to, those used in the Chinese, Japanese and Korean languages). For example, each of the multiple glyphs requested for the electronic document 226 can be a non-Latin glyph. Thus, the electronic document 226 can be presented using the system 208 and/or 210 such that the document includes the glyph(s) requested and received from the font database 204.

Further editing of the electronic document 226 can be performed. In some implementations, the system 208 and/or 210 can detect whether the editor enters one or more glyphs not already used in the document, and if necessary request and receive any such glyph(s) from the font database 204. The document 226 can be updated when a requested glyph has been received. In some implementations, a determination that the revised document includes at least another glyph not already stored on the local device can be performed upon a predetermined event, such as an explicit refresh command from the user or a period of user inactivity. For example, assume that the editor is working on a revision of the electronic document 226. After the user makes a change in the document and a certain time passes without further input from the user, the system can automatically determine whether the revised document requires any additional glyph(s) not already present. If so, the required glyph(s) can be requested. This and/or other functionality on the requesting device can be provided by execution of instructions in any form of script, such as by Javascript code.

More glyphs than currently required can be requested. For example, the glyphs requested from the font packager 212 and received in response need not only contain the glyphs entered in the document to that point. In some implementations, the application 214 and/or the system where it is implemented can be configured for making one or more assumptions and/or extrapolations based on likely use, and request the corresponding glyph(s) based thereon. For example, if a user enters the characters “abc” from the Latin alphabet, the entire range of characters a-z can be requested, in anticipation of further user input of Latin text.

In some implementations, an exception can be generated upon a condition being met, such as if a requested font does not exist in the font database 214. In contrast, one or more issues may be explicitly ignored. In some implementations, no exception may be generated for an invalid font range. For example, if a request is made for a font subset that includes one or more characters not present in the base font, the character(s) will be omitted/ignored in responding to the request.

The glyph(s) can be requested using an address of the font database 204. For example, each font covered by the font availability information can be identified by a font identifier. The sought glyph(s) can then be requested by contacting the font packager 212 with the identities of the font and the specific glyph(s). In some implementations, the necessary information for where to obtain fonts that are not embedded in the electronic document and not otherwise available to the receiving system can be included in the document 226. For example, the document 226 can include information that identifies the computer system 202 and/or the font package 212 as the resource for requesting a font for a document. In some implementations, the necessary information for obtaining fonts can be included in the applicable program handling the document, such as in a browser and/or in the frontend application 214. For example, the frontend application 214 can be installed both on the device where the document is created (e.g., on the system 202) and on the device where the document is to be edited (e.g., on the system 208). The program 214 can then use its internal identification of the computer system 202 and/or the font package 212 to seek and obtain the necessary font(s).

The end user system 210 can be used for accessing or editing one or more electronic documents. In some implementations, the end user system can include any kind of computer device, such as a personal computer, mobile device or a telephone. For example, an ad using a predefined font (such as a custom font) can be displayed on a device operated by a consumer.

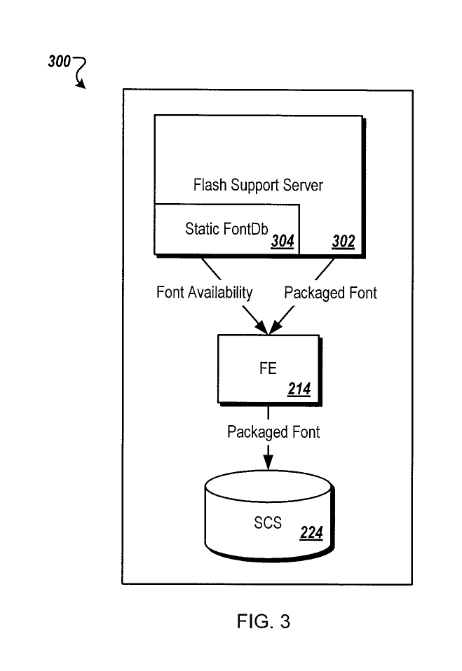

FIG. 3 shows an example system 300 that includes a font server 302. Components that in some implementations can correspond to those of the system 200 (FIG. 2) are identified using corresponding reference numbers. In some implementations, the server 302 implements the same interface as the font packager 212 and acts as a wrapper to block calls to a server. For example, an implementation that uses a standard client-server framework can allow a reduction or minimization of code dependencies in the frontend program 214.

A static font database 304 can be included in the system 300. In some implementations, the database 304 can allow only queries for available fonts. For example, the database 304 can be encapsulated in the server 302, such as to avoid application dependency (e.g., by the application 214) on the font data directly.

For example, a packaged font can be provided by the server 302 for receipt by the frontend application 214, such as for direct receipt by an end user system or an editor, or for placement in the server 224.

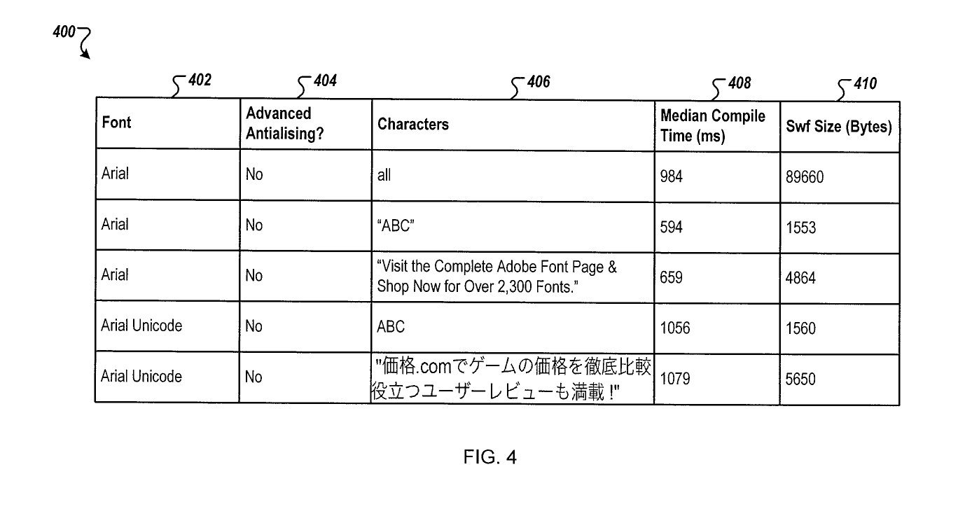

FIG. 4 shows a table 400 with example compile times and file sizes. Here, a font column 402 indicates which font is implicated by a particular character or characters. An antialiasing column 404 indicates whether advanced antialiasing is provided for the font identified in column 402. A character column 406 indicates which characters are defined using the identified font in each example. A compile time column 408 indicates the median compile time in milliseconds. A file size column 410 indicates a size in Bytes of a .swf file generated for the characters identified in the column 406.

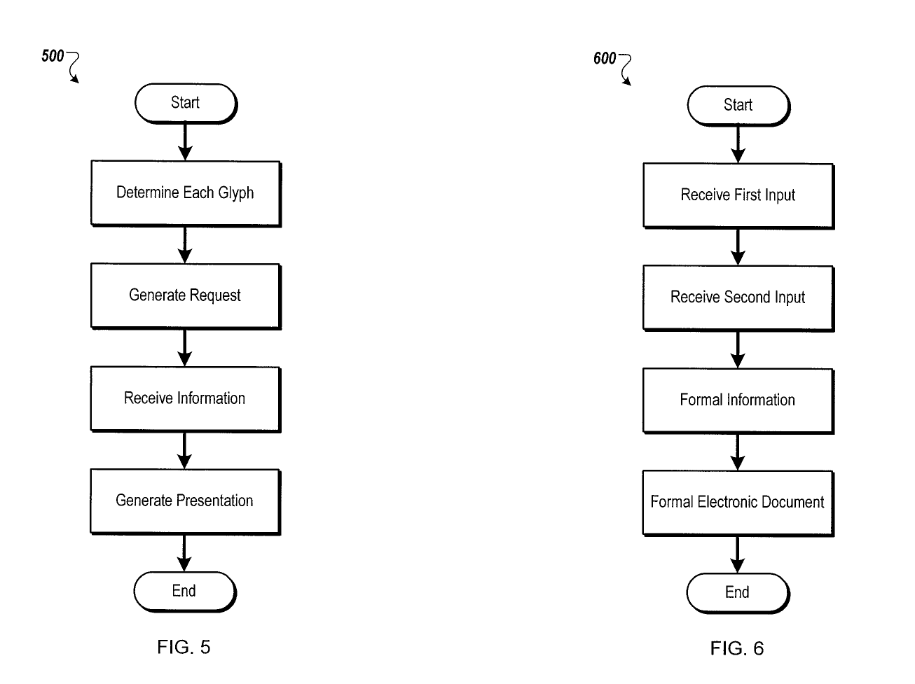

FIG. 5 shows a flowchart of an example method 500 for obtaining a font for a document. In some implementations, the method 500 can be performed by a processor executing instructions in a computer-readable medium, for example in system 200 and/or 300. In some implementations, more or fewer steps can be performed; as another example, one or more steps can be performed in another order.

In step 510, each glyph of a font that is specified in contents of an electronic document is determined. The determination identifies a subset of multiple glyphs included in the font. The subset is determined on a first device that does not have the font stored thereon. For example, the system 208 and/210 can determine the glyph(s) of the electronic document 226 for which the system does not have the corresponding font.

In step 520, a request is generated to a second device based on the determination. The request identifies the subset to the second device. For example, the system 208 and/or 210 can generate a request to the system 202 and/or the font packager 212.

In step 530, information is received at the first device. The information is sent from the second device in response to the request and defines the subset of the multiple glyphs. The information does not define a remainder of the multiple glyphs other than the subset. For example, the system 208 and/or 210 can receive from the font packager 212 a .swf file with only those glyphs of the font that the system 208/210 needs for presenting the document. If the document is subsequently revised, another request can be generated for any additional glyph(s) not covered by the first request.

In step 540, a presentation of the electronic document is generated using the received information. The presentation includes the subset of the multiple glyphs. For example, the system 208/210 can display, print or otherwise visualize the electronic document 226, such as in an editing program where a user can make document changes.

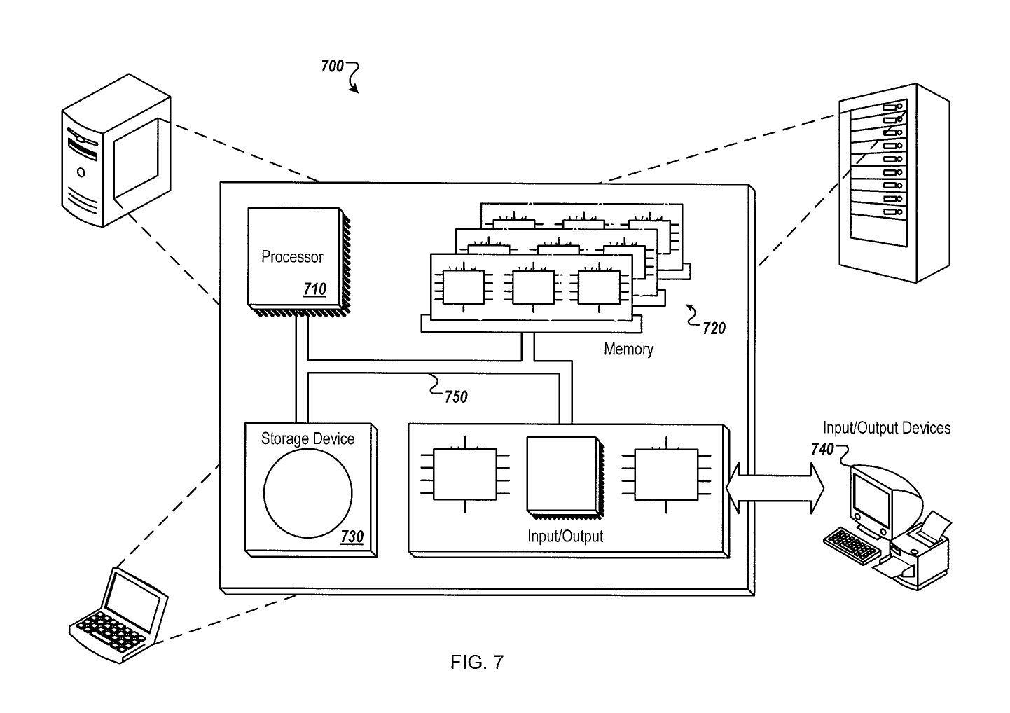

FIG. 6 shows a flowchart of an example method for providing a custom font for a document. In some implementations, the method 600 can be performed by a processor executing instructions in a computer-readable medium, for example in system 200 and/or 300. In some implementations, more or fewer steps can be performed; as another example, one or more steps can be performed in another order.

In step 610, a first input is received in a first device. The first input specifies a subset of multiple glyphs of a custom font to form contents of an electronic document. For example, a document creator can use the frontend application 214 to define the electronic document 226, such as an advertisement, to include characters of the font Felt Tip Roman Bold.

In step 620, a second input is received in the first device. The second input includes information defining the multiple glyphs of the custom font. For example, the creator can define the Felt Tip Roman Bold font using the frontend application 214. In step 630, the information is forwarded to a second device configured to provide the information upon request from a recipient of the electronic document. For example, the custom font can be uploaded to the font database 204 and/or to the font packager 212.

In step 640, the electronic document is forwarded to a third device that does not have the custom font stored thereon. The third device can request the information from the second device. For example, the system 202 can forward the electronic document 226 to the system 208/210, which can request the necessary glyph(s) from the font database 204 and/or from the font packager 212.

FIG. 7 is a schematic diagram of a generic computer system 700. The system 700 can be used for the operations described in association with any of the computer-implement methods described previously, according to one implementation. The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. The memory 720 is a volatile memory unit in some implementations and is a non-volatile memory unit in other implementations.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer-implemented method for obtaining a font for a document, the method comprising:
determining each glyph of a font that is specified in contents of an electronic document, the determination identifying a subset of multiple glyphs included in the font, the subset determined on a first device that does not have the font stored thereon;
generating on the first device a request to a second device based on the determination, the request identifying the subset to the second device;
receiving, at the first device, information sent from the second device in response to the request and defining the subset of the multiple glyphs, the information not defining a remainder of the multiple glyphs other than the subset; and
generating on the first device a presentation of the electronic document using the received information, the presentation including the subset of the multiple glyphs.

2. The computer-implemented method of claim 1, wherein a user makes a revision in the electronic document during the presentation, further comprising:
determining that the revision includes at least another glyph of the font not specified by the information;
generating a new request to the second device regarding the other glyph;
receiving additional information from the second device defining the other glyph; and
updating the presentation to display also the other glyph in the electronic document.

3. The computer-implemented method of claim 2, wherein the determination that the revision includes at least the other glyph is performed in response to detecting that a predetermined time passes after the user makes the revision.

4. The computer-implemented method of claim 1, wherein a first user creates the electronic document on a third device and wherein a second user modifies the electronic document on the first device.

5. The computer-implemented method of claim 4, wherein an application program is executed on the first and third devices and used in creating and modifying the electronic document.

6. The computer-implemented method of claim 5, wherein the application program has stored therein an address of the second device for requesting the information, and wherein the request is generated using the address.

7. The computer-implemented method of claim 5, wherein the electronic document has stored therein an address of the second device for requesting the information, and wherein the request is generated using the address.

8. The computer-implemented method of claim 1, wherein the electronic document includes an advertisement directed to a user operating the first device, and wherein the presentation includes displaying the advertisement to the user.

9. The computer-implemented method of claim 1, wherein the font is identified by a font identifier in the electronic document and each of the subset of the multiple glyphs is specified using a codepoint in the electronic document.

10. A computer-implemented method for providing a custom font for a document, the method comprising:
receiving a first input in a first device, the first input specifying a subset of multiple glyphs of a custom font to form contents of an electronic document;
receiving a second input in the first device, the second input comprising information defining the multiple glyphs of the custom font;
forwarding the information to a second device configured to provide the information upon request from a recipient of the electronic document; and
forwarding the electronic document to a third device that does not have the custom font stored thereon, wherein the third device requests the information from the second device.

11. The computer-implemented method of claim 10, wherein the electronic document includes an advertisement directed to a user operating the third device, and wherein the third device displays the advertisement to the user including the subset of the multiple glyphs.

12. The computer-implemented method of claim 10, wherein the font is identified by a font identifier in the electronic documents and each of the subset of the multiple glyphs is specified using a codepoint in the electronic document.

13. The computer-implemented method of claim 10, wherein the font comprises a non-Latin script and wherein each of the multiple glyphs is a non-Latin glyph.

14. A system comprising:
a font database comprising information defining at least one font comprising multiple glyphs; and
a font packaging component configured to receive a request from a device and in response forward information obtained from the font database, the information defining a subset of the multiple glyphs identified in the request and not a remainder of the multiple glyphs other than the subset.

15. The system of claim 14, further comprising an application program executed in the system and operated by a user to create the electronic document.

16. The system of claim 15, wherein the electronic document has stored therein an address of the font database for requesting the information, and wherein the device generates the request using the address.

17. The system of claim 15, wherein the application program is also executed on the device and has stored therein an address of the font database for requesting the information, and wherein the device generates the request using the address.

18. The system of claim 17, wherein the application program provides for a user of the device to enter a revision of the electronic document, and wherein the device generates a new request to the font server upon determining that the revision includes at least another glyph of the font not specified by the information.

19. The system of claim 15, further comprising a font server that includes the font database and the font packaging component, wherein the application program interacts with the font server in creating the electronic document.

20. The system of claim 19, wherein the font server communicates a font availability to the application program.
